(19) United States
(12) Patent Application Publication
(10) Pub. No.: US 2025/0382477 A1
(43) Pub. Date: Dec. 18, 2025

(54) ANTIBACTERIAL THERMOPLASTIC SUBSTRATE

(71) Applicant: GEHR-KUNSTSTOFF-EXTRUSIONSGESELLSCHAFT MBH, Mannheim (DE)

(72) Inventors: Wolfgang HÖLDERICH, Frankenthal (DE); Helmut GEHR, Schwetzingen (DE); Benjamin WASCHKE, Lambrecht (DE); Christian WILHELM, Meckenheim (DE); Andrea LÖSCH, Kaiserslautern (DE)

(21) Appl. No.: 18/879,205

(22) PCT Filed: Jun. 21, 2023
(86) PCT No.: PCT/EP2023/066736

§ 371 Date: Dec. 26, 2024

(30) Foreign Application Priority Data
Jun. 29, 2022 (DE) 10 2022 116 274.5

(51) Int. Cl. C09D 5/14; B33Y 70/10; C01B 39/02; C01B 39/38; C08K 3/34; C09D 7/62; C09D 7/80; C09D 181/06

(52) U.S. Cl. CPC C09D 5/14; B33Y 70/10; C01B 39/026; C01B 39/38; C09D 7/62; C09D 7/80; C09D 181/06; C08K 2003/343

(57) ABSTRACT

Antibacterial thermoplastic substrate and its uses, the substrate including at least one thermoplastic and at least one framework silicate, the framework silicate containing at least one antibiotic metal and/or antibiotic metal ion and the substrate having a silicate layer on at least a portion of the outer surface. The substrate is suitable for use as semi-finished products in the automotive industry, in mechanical engineering, in apparatus construction, for chemical plants, in tool manufacturing, in the pharmaceutical, food, and packaging industries, in the electrical and electronics sector, in sanitary and furniture manufacturing, in the water treatment and drinking water industry, in sealing materials such as silicone seals in bathrooms, in the manufacture of cosmetics and writing instruments, in the oil and gas industry, in medical products, and/or in construction products.

The invention relates to an antibacterial thermoplastic substrate for use in a wide variety of applications, comprising at least one thermoplastic and at least one framework silicate, the framework silicate containing at least one antibiotic metal and/or antibiotic metal ion and the substrate having a silicate layer on at least a portion of the outer surface. The invention further relates to the manufacture of such antibacterial thermoplastic substrates and use thereof in different products/materials, in particular for use as semi-finished products in the automotive industry, in mechanical engineering, in apparatus construction, in particular for chemical plants, in tool manufacturing, in the pharmaceutical, food, and packaging industries, in the electrical and electronics sector, in sanitary and furniture manufacturing, in the water treatment and drinking water industry, in sealing materials such as silicone seals in bathrooms, in the manufacture of cosmetics and writing instruments, in the oil and gas industry, in medical products, and/or in construction products.

### PRIOR ART

It has long been known that ions of silver, copper, or zinc, etc., possess antibacterial properties. For example, silver ions have been widely used in the form of a silver nitrate solution as a disinfectant or antibacterial agent. However, such a solution is tricky to handle and limited in its use. To overcome these disadvantages, a product was developed in which metal ions are carried by a solid such as zeolite.

Antimicrobial metal ions of silver, copper, zinc, and gold in particular are considered safe for use in vivo. Antimicrobial silver ions are especially useful for in vivo applications due to the fact that they are essentially not absorbed into the body. Silver ions have been impregnated into the surfaces of medical implants as described in U.S. Pat. No. 5,474,797. Silver ions have also been incorporated into catheters, as described in U.S. Pat. No. 5,520,664. However, the products described in these patents do not have an antibiotic effect for an extended period of time, because a passivation layer usually forms on the silver ion coating. This layer reduces the release rate of silver ions from the product, resulting in lower antibiotic effectiveness. In addition, the layer containing the silver often discolors, giving the products a poor appearance. The discoloration is caused by a high flux release rate of silver ions into the environment.

Antibiotic zeolites can be prepared by replacing all or part of the ion-exchangeable ions in the zeolite with antibiotic metal ions, as described in U.S. Pat. Nos. 4,011,898; 4,938,955; 4,906,464; and 4,775,585. Polymers incorporating antibiotic zeolites have been used to make refrigerators, dishwashers, rice cookers, plastic film, cutting boards, vacuum flasks, plastic buckets, and garbage containers. Other materials in which antibiotic zeolites have been incorporated include flooring, wallpaper, fabrics, textiles, paint, varnishes, coatings, napkins, plastic automobile parts, bicycles, pens, toys, sand, and concrete. Examples of such uses are described in U.S. Pat. Nos. 5,714,445; 5,697,203; 5,562,872; 5,180,585; 5,714,430; and 5,102,401.

Products in the medical field are subject to risk classification, which is based on the vulnerability of the human body to the respective product.

A conventional catheter for medical use is usually made of a hydrophobic polymer. When antibiotic zeolite is inserted into such a catheter, water cannot reach the zeolite in the bulk of the material. The majority of the zeolite is therefore ineffective against bacteria surrounding the catheter, because only the zeolite on the surface of the catheter is active.

Japanese patent application no. 03347710 relates to a nonwoven fabric bandage containing synthetic fibers and hydrophilic fibers. The synthetic fibers contain zeolite that is ion-exchanged with silver, copper, or zinc ions.

The bactericidal treatment of plastics with silver and silver alloy nanoparticles is described in the dissertation of Nikolay Stefanov Plachkov at Faculty III of the University of Saarland in May 2006.

U.S. Pat. No. 4,923,450 discloses the incorporation of zeolite into fillers or bulk materials. However, when zeolite is conventionally mixed or compounded into polymers, the zeolite often aggregates, causing poor dispersion of the zeolite in the polymer. When such material is molded or extruded, the surface of the polymer is often corrugated or beaded rather than smooth. Poor dispersion of the zeolite can also cause changes in the bulk properties of the polymer, such as a reduction in tensile strength. However, any significant changes in the bulk properties of medical devices such as catheters result in the need to seek regulatory approval from the U.S. Food and Drug Administration (FDA), which is an expensive and time-consuming process.

Based on the technical solutions that are known from the prior art and the problems described above, in particular the uncontrolled release of metals and/or metal ions, it is the object of the invention to provide an antibacterial polymer with improved properties in which the antibacterial, zeolitic additive is highly dispersed in the polymer.

### SUMMARY OF THE INVENTION

The object described above is achieved by means of an antibacterial thermoplastic substrate comprising at least one thermoplastic and at least one framework silicate, the framework silicate containing at least one antibiotic metal and/or an antibiotic metal ion and the substrate having a silicate layer on at least a portion of the outer surface.

The framework silicate component, particularly in the form of a zeolite component of the antibacterial thermoplastic substrate, serves as a storage medium for the antibacterial metals or metal ions. These metals/metal ions are released from the zeolite framework over time (“controlled release”). In particular, the additional silylation narrows the pore mouth of the zeolite and slows down the release of metal ions, making it more controllable.

A major advantage is that only inorganic, temperature-stable materials are used for the antibacterial properties of the thermoplastic. In contrast, the antibacterial thermoplastics available on the market are based on metals that are combined with organochemicals.

In contrast to the present antibacterial thermoplastics according to the invention, an antibacterial thermoplastic based on inorganic ZnO does not contain zeolite and does not act according to the principle of “controlled release.”

Therefore, the present description relates in particular to an antibacterial thermoplastic substrate comprising at least one thermoplastic and at least one framework silicate, the framework silicate containing at least one antibiotic metal and/or antibiotic metal ion, characterized in that the substrate has a silicate layer on at least a portion of the outer surface.

Furthermore, the present description relates to a method for manufacturing an antibacterial thermoplastic substrate comprising the steps:
a) applying/introducing the antibiotic metal and/or metal ion onto/into the framework silicate through ion exchange and/or impregnation,
b) silylating the metal-doped framework silicates,
c) mixing the silylated metal-doped framework silicates with the thermoplastic.

Furthermore, the present description relates to the use of the antibacterial thermoplastic substrate of the present description for the manufacture of medical, cosmetic, and/or construction products, for semi-finished products for automotive, mechanical, apparatus, and tool engineering, in particular for chemical plants, in the pharmaceutical, food, and packaging industries, in the electrical and electronics sector, in sanitary and furniture production, in water treatment and the drinking water industry, in sealing materials such as silicone seals in bathrooms, in the manufacture of cosmetic and writing instruments and/or in the oil and gas industry.

### BRIEF DESCRIPTION OF THE FIGURES

The antibacterial zeolites used in the antibacterial thermoplastics are characterized using physical methods of measurement. These include X-ray powder diffraction as shown in FIGS. 1 and 2, solid-state NMR (MAS-NMR) spectroscopy in FIG. 3, EDX spectroscopy (energy dispersive X-ray spectroscopy) and microspectroscopic images in FIG. 4, and temperature-programmed desorption with ammonia in FIG. 5.

Furthermore, to determine the antibacterial properties of the materials, optical density measurements at 600 nm (OD600) measurements were carried out (FIGS. 8 to 11). Literature for such a test can be found, for example, in G. Sezonov et al. in J. Bacteriology 189,23 (2007) p. 8746.

Furthermore, zone of inhibition tests (FIG. 13) were performed. These are described, for example, in ROMPP editorial team, Hemmhoftest [Zone of Inhibition Test], RD-08-00841 (2002) in Böckler F., Dill B., Eisenbrand G., Faupel F., Fugmann B., Gamse T., Matissek R., Pohnert G., Rühling A., Schmidt S., Sprenger G., RÖMPP [online], Stuttgart, Georg Thieme Verlag, [Dec. 2021] https://roempp.thieme.de/lexicon/RD-08-00841.

FIG. 1: X-ray powder diffractograms of silver ion-exchanged zeolites.

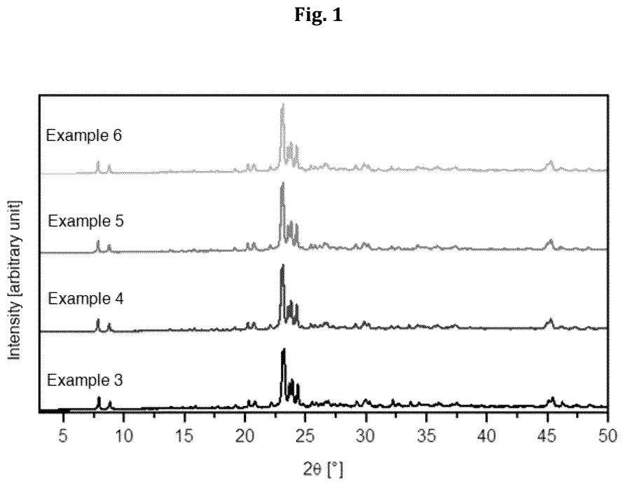

FIG. 2: X-ray powder diffractograms of the silylated zeolites and the parent zeolite AgZSM-5.

FIG. 3: ²⁹Si and ²⁷Al MAS NMR spectra of the silylated zeolites and the unsilylated AgZSM-5.

FIG. 4: SEM (left) and EDX (right) images of the silylated zeolites at a magnification of x1500: a) AgZSM-5-S1, b) AgZSM-5-S2, c) AgZSM-5-S3. Silver atoms are shown as white dots.

FIG. 5: NH3 TPD measurements of a) AgZSM-5, b) Ag-ZSM-5-S1, c) AgZSM-5-S2, d) AgZSM-5-S3.

FIG. 6: SEM (left) and calcium EDX (right) as well as silicon EDX (bottom) images of a PPSU filament doped with silver-loaded zeolite and calcium fluoride.

FIG. 7: OD600 measurements of zeolite NH₄ZSM-5, the Ag-exchanged zeolite from Example 1, and the singly silylated zeolite from Example 23

FIG. 8: OD600 measurements of zeolite NH₄ZSM-5 in comparison to 2 Ag-exchanged zeolites of Examples 8 and 10.

FIG. 9: Comparison of OD600 measurements of zeolite beta and an Ag-exchanged zeolite beta.

FIG. 10: SEM (left) and EDX (right) image of Ag-ZSM-5 (Example 1) in powder form. Ag atoms shown in gray (x500).

FIG. 11: Comparison of the silver release of PPSU granulate filled with Example 1, PPSU filament filled with Example 1, and the 3D-printed test specimens (Example 33)

FIG. 12: OD600 measurements of zeolite NH₄ZSM-5 compared to the 2 filaments from Example 34.

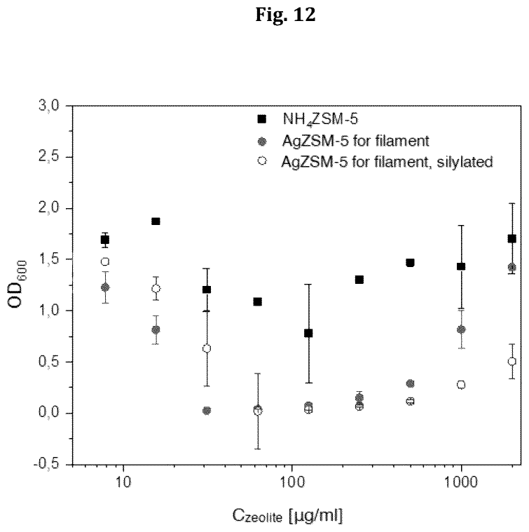

FIG. 13: Zone of inhibition test with unfilled PPSU filament (left) and PPSU filament filled with AgZSM-5 (right).

FIG. 14: Laser measurements of the filament from Example 37.

### DETAILED DESCRIPTION

The invention relates particularly to antibacterial thermoplastic substrates comprising at least one thermoplastic and at least one framework silicate, the framework silicate containing at least one antibiotic metal and/or antibiotic metal ion, characterized in that the substrate has a silicate layer on at least a portion of the outer surface.

The invention further relates to methods for manufacturing an antibacterial thermoplastic substrate of the present description, comprising the following steps:
a) applying/introducing the antibiotic metal and/or metal ion onto/into the framework silicate through ion exchange and/or impregnation, in particular also the “incipient wetness” method,
b) silylation of metal-doped framework silicates,
c) mixing the silylated metal-doped framework silicates with the thermoplastic, in particular followed by compounding and preferably the subsequent comminution thereof into chips or granules.

Methods for producing heterogeneous metal catalysts on supports by applying metal salt solutions to a porous solid support are known. A typical first step in the preparation of a supported catalyst is to apply an aqueous solution of a salt of a catalytic metal or metals to the solid support. The “incipient wetness” method, sometimes also called “pore volume saturation” method, is a typical method for impregnating a solid support with the catalytic metal salt, as it ensures a higher dispersion of the metal salts in the pores of the support.

For example, the incipient wetting technique requires the following steps, namely (1) forming a saturated aqueous solution of a salt of the catalytic metal or metals, (2) contacting the support with a limited quantity by volume of the metal salt solution to soak up the solution, (3) contacting the support with a limited quantity by volume of the catalytic metal salt solution in order to soak up the solution, the volume of the catalytic metal salt solution approaching but not exceeding the measured pore volume of the support, (4) removing the soaked water from the support by thermal drying, (5) measuring the mean lower pore volume of the support solids, and (6) repeating steps (1) through (4) until the desired metal loading is achieved, the solution volumes being adjusted to the lower pore volume between each cycle of steps.

In a first aspect, the present invention relates to an antibacterial thermoplastic substrate comprising at least one thermoplastic and at least one framework silicate, the framework silicate containing at least one antibiotic metal and/or antibiotic metal ion, characterized in that the substrate has a silicate layer on at least a portion of the outer surface.

Thermoplastics according to the present invention include all standard thermoplastics, engineering thermoplastics, and all high-temperature thermoplastics. Examples of standard thermoplastics are polyethylene (PE), polypropylene (PP), polyvinyl chloride (PVC), and polystyrene (PS). Engineering thermoplastics are polyamides PA 12, PA 11, and PA 6, polyoxymethylene (POM), polyphenylene ether (PPE), polycarbonate (PC), polyethylene terephthalate (PET), polypropylene terephthalate (PPT), polybutylene terephthalate (PBT), polyethylene naphthalate (PEN), polycarbonates (PC), polyacrylonitrile (PAN), polyacrylic acid (PAC) and their esters such as butyl ester, polymethyl methacrylate (PMMA), polylactic acid (PLA), polyethylene furanoate PEF and other esters of the 2.5-furandicarboxylic acid (FDCA), polytetrafluoroethylene (PTFE), polyvinylidene (PVDF), polyetherimide (PEI), and silicones such as polydimethylsiloxane (PDMS).

Copolymers such as polyacrylic butadiene styrene (ABS), polyacrylic styrene (SAN), polyacrylate rubber (ACM), and polyacrylonitrile (chlorinated polyethylene) styrene (ACS) are also used for the addition of the antibacterial zeolite.

The antibacterial zeolites can also be added to thermosets such as epoxy resins, phenolic resins, formaldehyde resins, polyurethanes, urea and melamine resins, polyester resins, and silicones as well as to elastomers such as styrene-butadiene rubber (SBR), nitrile rubber (NBR), chloroprene rubber (CR), fluoropolymer rubber (FKM), butadiene rubber (BR), ethylene-propylene-diene rubber (EPDM), natural rubber, and silicones.

Examples of high-performance plastics, in particular high-temperature thermoplastics, are polyetheretherketone (PEEK), polyetherketone (PEK), thermoplastic polyimides (TPI), polysulfone (PSU), polyethersulfone (PES), polyphenylenesulfone (PPSU), polyphenylene sulfide (PPS).

To further improve the mechanical and thermal properties of thermoplastics, fiber reinforcing materials and other additives can be added. Such materials include glass fibers, carbon fibers, glass beads, PET fibers, carbon black, graphite, Teflon, dyes, talc, and biological fibers such as cellulose, starch, lignin, and polyglycerol.

In a particular embodiment of the present invention, the thermoplastic used in the antibacterial thermoplastic substrate according to the invention is polyetheretherketone (PEEK), polyoxymethylene (POM), polyvinyl chloride (PVC), polyethylene (PE), polystyrene (PS), or polyphenylsulfone (PPSU) and mixtures thereof.

The antibacterial thermoplastic substrate further comprises a framework silicate. Framework silicates (tectosilicates) are silicates whose silicate anions consist of a skeleton of corner-sharing SiO₄ and AlO₄ tetrahedra. These are called aluminosilicate zeolites. In these silicate frameworks, Al can also be replaced by B or Ti. Then they are referred to as borosilicate zeolites or titanium silicate zeolites such as TS-1.

Borosilicate zeolites are synthesized, for example, at 90° C. to 200° C. under autogenous pressure by reacting a boron compound such as boric acid with a silicon compound, preferably highly dispersed silica, in an aqueous amine solution such as 1,6-hexamethylenediamine, in particular without the addition of alkali or alkaline earth metals. Such syntheses are described, for example, in EP-A-34727, EP-A-46504, EP 198437 B1, EP 77946 A2, and EP 423530 B1.

Titanium silicate zeolites such as TS-1 are described by B. Kraus-haar et al. in Catalysis Letters 1 (1988), pp. 81-89, C. Perego et al. in Stud. Surf. Sci. Catal. 28 (1986), pp. 129-136, and in EP 111700 B1.

The technically important and also naturally occurring minerals of the zeolite group are framework silicates. The silicate frameworks enclose larger cavities in which cations such as Na⁺, K⁺, C^{s2+}, Ca²⁺, Ba²⁺, Sr²⁺, and H⁺ or also ions and molecules such as [NH₄]⁺, water, or other complex anions such as SO₄ can be accommodated. Due to their mostly loose structure, the framework silicates are characterized by low density, low light refraction, and medium hardness. Many of the alumo-, boro-, and titanium silicate frameworks are permeated by wide, open channels that can absorb and release water or cations, for example, without causing the silicate framework to become unstable. This is the basis for the technical application of these minerals as ion exchangers or molecular sieves or drying agents or adsorbents.

A distinction is drawn between small-, medium-, wide-, and super-wide-pore zeolites. In small-pore zeolites, whose pore mouth is formed by 8 tetrahedra—i.e., with an 8-ring pore opening—the size of the channel diameter is between about 3 and about 4.5 Ã, such as chabazite at 3.8×3.8 Ã, rho zeolite at 3.6×3.6 Ã, and A-zeolites such as 3A zeolite and erionite at 3.6×5.1 Ã. The medium-pore zeolites with 10-ring pore opening and channel diameters between about 4 and 6 Ã include the pentasil zeolites such as ZSM-5 (MFI) at 5.1×5.5 Ã, ZSM-11 (MEL) at 5.3×5.4 Ã, ferrierite (FER) at 4.2×5.4 Ã, MCM 22 (MWW) at 4.0×5.5 Ã, and theta-1 zeolite (TON) at 4.6×5.7 Ã. The large-pore zeolites have a pore opening of 12 tetrahedra, i.e., a 12-ring structure. These include faujasite (FAU)=Y- and X-zeolites at 7.4×7.4 Ã, BETA-zeolite (BEA) at 6.6×6.7 Ã, L-zeolite (LTL) at 7.1×7.1 Ã, mordenite (MOR) at 6.5×7.0 Ã, ZSM-12 (MTW) at 5.6×6.0, and offretite (OFF) at 6.7×6.8 Ã.

An overview of the different zeolite structures and their pore diameters can be found in Ch. Baerlocher et al., Atlas of Zeolite Framework Types, 5th revised edition, Elsevier 2001.

Either natural zeolites or synthetic zeolites can be used to prepare the antibiotic zeolites used in the present invention. For example, “zeolite” is an aluminum silicate that has a three-dimensional basic structure represented by the formula: XM₂/nO-Al₂O₃—YSiO₂—ZH₂O. M stands for an ion-exchangeable ion, usually a monovalent or divalent metal ion; n stands for the atomic valence of the (metal) ion; X and Y stand for coefficients of metal oxide and silica, respectively; and Z stands for the number of water of crystallization. Examples of such zeolites include A-type zeolites, X-type zeolites, Y-type zeolites, T-type zeolites, L-type zeolites, high-silica zeolites such as the pentasil zeolites ZSM-5 and ZSM-11, then sodalite, mordenite, analcite, clinoptilolite, chabazite, and erionite.

In a particular embodiment, the framework silicate is a zeolite, in particular a zeolite of the class of the aluminosilicates, in particular an ion-exchanged zeolite and particularly a zeolite that has been ion-exchanged with ammonium ions. In particular, the aluminosilicates are of the structural type of the group consisting of ZSM-5, of the BEA, MOR, L, Y, or X zeolite as well as theta zeolite or mixtures thereof.

In a particular embodiment of the antibacterial thermoplastic substrate of the present invention, only inorganic temperature-stable materials are used for the antibacterial properties of the thermoplastics, meaning that the framework silicate is also temperature-stable. The temperature stability of zeolites is above 500° C. and sometimes up to 700° C. before the zeolite framework collapses. The thermoplastics loaded with antibacterial, metal-modified zeolites have a temperature stability of between 70° C. and 350° C., in particular between 90° C. and 250° C., and especially between 150° C. and 220° C.

In antimicrobial zeolite particles used in the preferred embodiment of the present invention, ion-exchangeable ions present in the zeolite, such as sodium ions, calcium ions, potassium ions and iron ions, are partially replaced by ammonium and antimicrobial metal ions. Such ions can coexist in the antimicrobial zeolite particle because they do not prevent the bactericidal effect. Examples of antimicrobial metal ions include but are not limited to ions of silver, gold, copper, zinc, mercury, cobalt, nickel, tin, lead, bismuth, cadmium, chromium, and thallium. Preferably, the antibiotic metal ions are silver, copper, or zinc ions, and silver is most preferably used. These antimicrobial metal ions can be incorporated into the zeolite alone or in a mixture.

The antimicrobial metal ion is preferably in the range of about 0.1 to about 15% by weight of the zeolite, based on 100% total weight of the zeolite, in particular between 0.5% by weight and 10% by weight and very especially between 2% by weight and 8% by weight. In one embodiment, the zeolite contains from about 0.1 to about 15% by weight of silver ions and from about 0.5 to about 8% by weight of copper or zinc ions. Although ammonium ions may be present in the zeolite at a concentration of up to about 20% or less by weight of the zeolite, it is desirable to limit the ammonium ion content to from about 0.5 to about 2.5% by weight of the zeolite, more preferably to from about 0.5 to about 2.0% by weight, and most preferably to from 0.5 to about 1.5% by weight.

Antimicrobial zeolites, including the antimicrobial zeolites disclosed in U.S. Pat. No. 4,938,958, are well known and can be prepared for use in the present invention using known methods. These include the antimicrobial zeolites that are disclosed in U.S. Pat. No. 4,938,958. The invention is not limited to the use of these specific zeolites.

The ion exchange capacities of these zeolites are as follows: A-type zeolite=7 meq/g; X-type zeolites=6.4 meq/g; Y-type zeolites=5 meq/g; ZSM-5 type=0.783 meq/g (Na-ZSM-5, SiO₂/Al₂O₃=39.9 (A. So. Zola et al., Brazilian Journal of Chemical Engineering, vol. 29, no. 02, 2012, pp. 385-392), T-type zeolites=3.4 meq/g; sodalite=11.5 meq/g; mordenite=2.6 meq/g; analcite=5 meq/g; clinoptilolite=2.6 meq/g; chabazite=5 meq/g; and erionite=3.8 meq/g. These ion exchange capacities are sufficient for the zeolites to undergo ion exchange with ammonium and antibiotic metal ions.

Silylation of zeolites is a method for passivating the outer surface of a zeolite. This is covered with a silicate layer, which can have varying thicknesses. By covering the outer surface with a silicate layer, the pore mouth of the zeolite channels/zeolite pores can also be narrowed. There are different methods of silylation:
Application of the CLD=Chemical Liquid Deposition method. Here, the zeolite such as ZSM-5 is suspended in a solvent such as n-hexane and heated to reflux temperature. Tetraethyl orthosilicate (TEOS) is added to the zeolite suspension under stirring and left to react at reflux temperature for 1 to several hours. The solvent is then removed, and the silylated zeolite is dried and calcined. See: S. Zheng et al., Topics in Catalysis, vol. 22, nos. 1/2 Jan. 2003, pp. 101-106, Pit Losch et al., General 509 (2016) 30-37Adrian Ghorbanpour et al. ACS Nano 9.4 (2015) 4006-4016 Mobil Oil Corp. US 5,243-117, 1993, and 5,349114, 1994 R W Weber et al., Microporous and Mesoporous Materials 23 (1998), p. 179 et seq.
Application of the CVD=Chemical Vapor Deposition method. The application takes place in a vacuum, and the vapor of the silylating agent is applied to the dried zeolite. Such a process is described, for example, by Miki Niwa et al. in J. Chem. Soc. Faraday Trans. I, 1994, 80, p. 3135 et seq. for the preparation of a silylated mordenite. See also Miki Niwa et al., J. Catal. 134 (1992), p. 340 et seq.
In the commercialized NITTO process, di- and monomethylamine are preferentially produced from CH₃OH and NH₃ on zeolites such as ZSM-5 and mordenite, whose pore mouths have been reduced through silylation. The formation of the less desirable trimethylamine is largely suppressed as a result of the reduction in pore diameter. See: K. Tanabe and W. Hölderich, Appl. Catal. A: General 181 (1999) 399-434, W. Hölderich in J.-M. Lehn et al., Comprehensive Supramolekular Chemistry, vol. 7. (1996) 671-692.

One important feature of the antibacterial thermoplastic substrate of the present invention is that the substrate has a silicate layer on at least a portion of the outer surface. This is achieved through silylation of the metal-doped framework silicates. Silylation refers to chemical reactions in organic chemistry in which the products are derived from silane derivatives (derivatization). Silylation with the formation of a siloxane bond (Si—O—Si) is of particular importance in the manufacture of silicone materials (Siegfried Hauptmann: Organische Chemie [Organic Chemistry], 2nd edition, VEB Deutscher Verlag für Grundstoffindustrie, Leipzig 1985). As a result of the silylation of the antibacterial thermoplastic substrate or of the metal-doped framework silicates, the substrate has a silicate layer on at least a portion of the outer surface, which leads to a narrowing of the pore mouth of the zeolite and slows down the release of the metal ions.

In particular, the silylation of the framework silicate is carried out through treatment with silicon compounds such as tetrachlorosilane, trichlorosilane, dichlorosilane, monochlorosilane, and in particular organosilicon compounds such as triphenylsilane, triphenylchlorosilane, phenyltrichlorosilane, trimethylchlorosilane, tetramethylsilane, tetraethylsilane, triethylchlorosilane, and/or diethylchlorosilane.

After application of the silylating agent, the zeolitic material is dried at from 120° C. to 160° C. and then calcined at temperatures between 450° C. and 600° C., preferably between 500° C. and 550° C. As a result of the calcination under oxygen, the organic components of the silylating agent are burned out, and a SiO₂ layer remains on the outer surface of the zeolite. Through the use of silylation methods, a pore mouth constriction of from 0.05 nm to 0.3 nm or even greater can be achieved.

Furthermore, the metal-doped, silylated framework silicate can be subjected to tempering. Tempering in the sense of the present invention refers in particular to chemical tempering, a process for giving solids a more regular structure. In the chemical sense, tempering means that a solid is heated to a temperature below its melting point. This occurs over a longer period of time (from a few minutes to a few days), and structural defects are compensated for and the crystal structure is improved in the short and long term. The process of melting and extremely slow cooling to adjust the crystal structure is thus avoided.

Another suitable method for preparing the antibacterial thermoplastic substrate is as follows: Antibacterial zeolite is dispersed in an effective amount in an organic solvent in order to form a first dispersion. The thermoplastic is dissolved in an organic solvent. Polar solvents such as acetone, ethanol, butanol, hexanol, and other short-chain alcohols, diethyl ether, acetonitrile (ACN), sulfuric acid, hydrochloric acid, nitric acid, and phosphoric acid are used as solvents. Methanesulfonic acid (MSA), carboxylic acids such as formic acid and acetic acid, primary and secondary amines and amides such as formamide and dimethylformamide (DMF), as well as non-polar solvents such as alkanes like n-hexane and petroleum ether, the aromatics toluene, xylene, mesitylene, and other alkyl-substituted aromatics, carbon tetrachloride, chloroform, and carboxylic acid esters such as ethyl acetoacetate are used. This second solution is obtained by mixing the thermoplastic in the solvent at from about 20° C. to about 70° C., more preferably from about 25° C. to about 60° C., and most preferably from about 40° C. to about 60° C. The heating is performed in an explosion-proof container such as an autoclave. The concentration of solvent in the second solution is preferably in the range of from about 1 to about 15% by weight, more preferably from about 0.5% by weight to about 10% by weight, and most preferably from about 1% by weight to about 5% by weight. The first solution and second solution are then mixed to form the antibacterial thermoplastic substrate of the invention.

As described previously, the present invention comprises a method for manufacturing an antibacterial thermoplastic substrate comprising the steps of:
a) applying/introducing the antibiotic metal and/or metal ion onto/into the framework silicate through ion exchange and/or impregnation,
b) silylating the metal-doped framework silicates,
c) mixing the silylated metal-doped framework silicates with the thermoplastic, followed by compounding and comminution to granules or chips.

The mixing of the antibacterial zeolite with the thermoplastic can also preferably be carried out in a solvent-free manner, i.e., with dry substances in a so-called compounding process. The mixture of thermoplastic and metal-doped, silylated framework silicate can be compounded using conventional methods and then processed into granulate. Compounding is a process in which molten polymers are mixed with other additives. This process changes the physical, optical, mechanical, thermal, electrical, aesthetic, or even antibacterial properties of the plastic. Compounding optimizes the properties of plastics. The end product is called a compound or composite material.

Through the addition of a variety of additives, fillers, and reinforcing agents, numerous properties relating to conductivity, flame retardancy, abrasion resistance, structural behavior, and colors can be achieved. The additives are independently selected based on specific performance criteria. For example, glass fibers can be added in different quantities in order to increase the rigidity of a plastic that is too flexible.

The thermoplastic and the additive/additives can be added separately into the compounding extruder. Or mechanical mixing is carried out in order to homogenize the two components before being added to the compounding extruder.

It is also possible to use direct extrusion after compounding.—So not the process of mixing, compounding, granulating, extrusion as a shaping process, but rather mixing, compounding and, immediately afterward, the shaping extrusion. By avoiding a granulation step and a second melting step, energy is saved and the material is subjected to significantly less thermal stress.

This compounding process usually proceeds as follows: The plastic granulate is dosed together with the additives—in this case the antibacterial zeolite—simultaneously into a compounding extruder.

When heated, the thermoplastic is melted at temperatures between 70° C. and 450° C., preferably between 220° C. and 300° C., and the additives contained are evenly distributed in the melt using special mixing elements. The melt is conveyed out of the extruder via a perforated plate. The individual melts are processed again into granulate via a hot or cold die.

Consequently, compounding takes place in several steps. Plastic and additive(s) are mixed in an extruder. The compound melt exits the extruder in strands with a thickness of from about 2 mm to 8 mm, especially from 3 mm to 5 mm. These strands are cooled and cut into granulate. The granulate is carefully inspected and subjected to quality control.

Various processes are used for the subsequent processing of the compounded thermoplastic granulate loaded, for example, with the antibacterial zeolite. The two most important are extrusion and injection molding. Other manufacturing processes include calendering, rotational molding, foaming, blow molding, casting, sintering, pressing, pultroding, ram extrusion, and possibly a shear roll mixing system.

Depending on the product, a distinction can be made between different extrusion processes. For example, there is the manufacture of technical semi-finished products (solid rods, tubes, plates, and profiles), the manufacture of films and wires, and the manufacture of filaments for 3D printing.

For example, in the manufacture of tubes, the compounded granulate is fed into an extruder. This plasticizes the polymer and conveys the melt through a die that usually consists of a flange, a mandrel holder, a nozzle, and a mandrel. This gives the melt its shape. In order to subsequently cool the melt again and create and maintain the final shape, the melt is pulled through a calibration. There, the melt is applied to the calibration using an applied negative pressure. Cooling is performed using a cooling medium, usually water. An extractor system is used for continuous removal. The tubes are then cut to the required length using a cutting device. The length of the tubes is selected depending on the intended use. This can be a few millimeters for small applications up to many meters, such as with hoses. These are lengths from 0.1 mm to 30 m, especially 10 mm to 500 mm, particularly 114+/−0.5 mm. 131+/−0.7 mm, but also bars measuring 3 m+/−3%.

For example, when producing filaments for 3D printing, the granulate to be processed is fed into an extruder. This plasticizes the polymer. Since filament manufacturing requires very tight tolerances, the melt is transported out of the extruder using a melt pump. This method ensures a continuous volume flow. After leaving the nozzle, the melt is cooled in air or in a water bath until it solidifies. An extractor performs the continuous removal of the produced filament. To simplify further handling, the filament is wound onto spools after extraction.

The diameters of the filaments are in the range of from 1.0 mm to 5 mm, preferably from 1.5 mm to 3.5 mm. The standard diameters are 1.75 mm and 2.85 mm. When the material is used as threads, much smaller diameters of from 0.01 mm to 0.03 mm are common. Filaments are sold by weight. Coil weights of from 0.1 kg up to 10 kg are common.

Various methods are used to control the quality of the products produced. Laser and ultrasonic measuring heads are used, among other things. Laser measuring heads work according to the shadow principle. The material passed through the measuring head obscures a specific area of a laser beam. This hidden area can be identified, and the measurement to be determined can be determined therefrom. Ultrasonic measuring heads emit a sound pulse. If this pulse strikes an object having a different density, a portion of the signal is reflected. The time interval when the sound waves strike a receiver is measured. This measurement can be used to calculate the wall thickness of tubes, for example.

In particular, the antibacterial thermoplastic substrates according to the invention can be used for the manufacture of medical, cosmetic, and/or construction products and/or semi-finished tools in automobile construction, mechanical engineering, tool parts, apparatus construction, in particular for chemical plants, in tool manufacturing, in the pharmaceutical, food, and packaging industries, in the electrical and electronics sector, in sanitary and furniture manufacturing, in the water treatment and drinking water industry, in sealing materials such as silicone seals in bathrooms, in the manufacture of cosmetics and writing instruments, in the oil and gas industry, in medical products, and/or in construction products.

The antibacterial properties of the antibacterial thermoplastic substrates of the invention can be tested using known testing techniques, for example by determining the minimum growth inhibitory concentration (MIC) in relation to a variety of bacteria, eumycetes, and yeast. The bacteria listed below can be used in such a test:
Bacillus cereus var mycoides, Escherichia coli, Pseudomonas aeruginosa, Staphylococcus aureus, Streptococcus faecalis, Aspergillus niger, Aureobasidium pullulans, Chaetomium globosum, Gliocladium virens, Penicillum funiculosum, Candida albicans, Saccharomyces cerevisiae.

The physiology of Escherichia coli is described, for example, by G. Sezonov et al. in J. Bacteriology 189,23 (2007), p. 8746. This method is used in the examples given.

The following experimental examples illustrate the invention described.

### Example 1

125 g of silver nitrate are dissolved in 10 L of distilled water and placed in a 15-L glass stirring vessel with jacket heating and propeller stirrer under exclusion of light. Under stirring at 50° C., 500 g of NH₄ZSM-5 from Zeolyst International, designation CBV 2314, are slowly added via a powder funnel. Afterward, stirring is performed at 50° C. for 5 h. The pH value is set to 7 using ammonia or diluted nitric acid. After completion of the ion exchange, the solid is filtered off and washed with approximately 7 L of distilled water. The solid is dried at ambient temperature for 12 h and then at 120° C. for 6 h to 48 h. The ion-exchanged ZSM-5 zeolite was calcined under the following conditions: heated from 150° C. at 2 K/min to 560° C. and calcined at 560° C. for 16 h.

With this ion exchange, an Ag content of 9.9% by weight is achieved in the calcined AgZSM-5. This corresponds to an exchange rate of 78.0% of the maximum exchange capacity.

The AgZSM-5 produced here is the zeolite material that was used in compounding.

### Example 2

This ion exchange was carried out in principle as described in Example 1, but only a 0.05 M aqueous AgNO₃ solution was used. This silver nitrate solution (0.05 M, in 200 ml water) was heated to 50° C. in a 250 ml Erlenmeyer flask under stirring with a magnetic stirrer under exclusion of light. 2.0 g of CBV 2314 were slowly added and stirred for 5 h. The pH value was set to a value of 7.0 using 25% ammonia solution or diluted nitric acid. The solid was then filtered off, washed with bi-distilled water, and dried at ambient temperature.

The Ag content of the dried AgZSM-5 is 10.2% by weight. This corresponds to an exchange rate of 80.3% of the maximum exchange capacity.

The comparison of Examples 1 and 2 shows that the Ag content can be adjusted by the selected quantity of AgNO₃.

### Examples 3 to 6

The ion exchange is carried out as described in Example 2, but 25° C., 40° C., 60° C., or 80° C. are set as ion exchange temperatures. A 0.05 M aqueous silver nitrate solution in 200 ml of bi-distilled water is heated to the desired temperature in a 250 ml Erlenmeyer flask under stirring with a magnetic stirrer under exclusion of light. 2.0 g of CBV2314 are slowly added to the solution and stirred at the appropriate temperature for 6 h. The pH value is adjusted to a value between 7.0 and 7.1 using 25% NH3 solution or diluted HNO₃. The solid is filtered off, washed with double-distilled water, and then further processed as described in Example 1.

TABLE 1
Ag content of Ag ion-exchanged ZSM-5 zeolites

| Example | Zeolite | Temp. ° C. | Ag [wt %] | Exchange rate % |
|---|---|---|---|---|
| 3 | AgZSM-5 | 25 | 10.3 | 81.1 |
| 4 | AgZSM-5 | 40 | 11.3 | 89.0 |
| 5 | AgZSM-5 | 60 | 13.2 | 103.9 |
| 6 | AgZSM-5 | 80 | 12.1 | 95.3 |

The X-ray powder diffractograms of these materials show that the zeolite structure is not affected by the ion exchange and temperature selection. No reflection attributable to elemental silver was observed.

The comparison of Examples 3 to 6 shows that the silver content can be adjusted within certain limits through the selection of the temperature.

### Examples 7 to 15

A 0.01 M silver nitrate solution in distilled water is heated to the desired temperatures of 40° C., 60° C., or 80° C. in a 250 ml Erlenmeyer flask under stirring with a magnetic stirrer under exclusion of light. 2.0 g CBV 2314 are slowly added to the solution and stirred for 3×2 h, 2×3 h, or 1×6 h at the corresponding temperatures. The pH value was set between 7.0 and 7.1 using 25% aqueous NH3 solution or diluted HNO₃. After the ion exchange period, the solid is filtered off and washed with distilled water and then dried at room temperature.

TABLE 2
Ag content of Ag ion-exchanged zeolites. AgZSM-5

| Example | Temp. ° C. | Time h | Ag [wt %] | Exchange % |
|---|---|---|---|---|
| 7 | 40 | 3 × 2 | 11.5 | 90.6 |
| 8 | 40 | 2 × 3 | 7.8 | 61.4 |
| 9 | 40 | 1 × 6 | 9.5 | 74.8 |
| 10 | 60 | 3 × 2 | 8.9 | 70.1 |
| 11 | 60 | 2 × 3 | 10.2 | 80.3 |
| 12 | 60 | 1 × 6 | 20.4 | 160.6 |
| 13 | 80 | 3 × 2 | 15.5 | 122.0 |
| 14 | 80 | 2 × 3 | 10.0 | 78.7 |
| 15 | 80 | 1 × 6 | 14.7 | 115.7 |

The comparison of Examples 7 to 15 demonstrates that the utilization of the maximum ion exchange capacity can be adjusted by choosing the temperature and renewal of the silver nitrate solution.

### Examples 16 to 18

3.0 g of NH₄ZSM-5 CBV 2314 are converted into the Na form through ion exchange with 300 ml of a 0.25 M NaNO₃ solution at 80° C. three times for 2 h.

Furthermore, 3.0 g of NH₄ZSM-5 CBV 2314 are converted into the H form of the zeolite through calcination in the following conditions: 2 h at 120° C., heat to 560° C. at 1 K/min and calcine for 16 h at 560° C.

0.05 M of silver nitrate solution in 200 ml of double-distilled water are heated to 50° C. in a 250 ml Erlenmeyer flask under stirring with a magnetic stirrer under exclusion of light. 2.0 g of the respective zeolites NaZSM-5, NH₄ZSM-5, or HZSM-5 are slowly added to the AgNO₃ solution and stirred at 50° C. for 5 h. The opening of the Erlenmeyer flask is covered with a watch glass dish. The pH value is adjusted to a value between 7.0 and 7.1 using NH₃ (25% aqueous solution) or diluted HNO₃. After the ion exchange period, the solid is filtered off, washed with distilled water, and dried at room temperature.

TABLE 3
Ag content of silver ion-exchanged zeolites.

| Example | Zeolite | Counterion | Ag[wt %] | Exchange % |
|---|---|---|---|---|
| 16 | AgZSM-5 | Na⁺ | 9.1 | 71.7 |
| 17 | AgZSM-5 | NH₄⁺ | 10.2 | 80.3 |
| 18 | AgZSM-5 | H⁺ | 8.4 | 66.1 |

The comparison of Examples 16 to 18 shows the influence of the counterion in the zeolite on the utilization of the maximum ion exchange capacity and the Ag content. The zeolite in the ammonium form is best suited for ion exchange.

### Example 19

This example demonstrates the impregnation of zeolite with silver. 2.0 g of zeolite NaZSM-5 (nₛᵢ/n_{Al}=40) are dried at 135° C. for 16 h. 0.3 g of AgNO₃ are dissolved in 0.932 g of distilled water. The silver nitrate solution is added directly to the zeolite using a pipette and immediately mixed with a spatula. The silver nitrate solution is almost completely absorbed. The impregnated zeolite is dried for 16 h at ambient temperature. The silver loading is 10.0% by weight.

### Examples 20 to 22

These examples demonstrate the additional loading of an Ag-exchanged zeolite with calcium. 2.0 g of AgZSM-5 from Example 1 with 9.9% by weight of Ag are dried at 135° C. for 12 h. Calcium nitrate tetrahydrate was dissolved in 1.23 g of distilled water, added directly to the Ag zeolite using a pipette, and immediately mixed with a spatula. The Ca(NO₃)₂ solution is almost completely absorbed. This now Ca-impregnated AgZSM-5 was dried at ambient temperature for 12 h and then calcined at 500° C. for 4 h.

TABLE 4
Weighed-in quantities for the impregnation of Ag-
loaded zeolites with calcium nitrate tetrahydrate.

| Example | Zeolite | m_{Ca(NO}_{₃}_{)2xH}_{₂}_{O} [g] | Ca loading [wt %] |
|---|---|---|---|
| 20 | AgZSM-5 | 0.246 | 2.0 |
| 21 | AgZSM-5 | 0.473 | 4.1 |
| 22 | AgZSM-5 | 0.717 | 6.0 |

The silver content in the zeolite is not changed as a result of the additional impregnation with calcium. The additional impregnation of the AgZSM-5 zeolite with calcium is intended to introduce basic centers in order to slow down the release of silver and counteract attack by acids. Such additional impregnations can also be carried out using other cations such as Mg, La, transition metal cations.

### Examples 23 to 25

These examples demonstrate the implementation of silylation. 2.0 g of AgZSM-5 from Example 1 with 9.9% by weight of Ag are suspended in 50 ml of n-hexane in a 100 ml round-bottom flask with a magnetic stirrer and heated under reflux. 0.3 ml of pure tetraethyl orthosilicate are added to the suspension and stirred under reflux for one hour. The solvent n-hexane is removed under vacuum. The solid was calcined under the following conditions: from 20° C. to 120° C. at 5 K/min, maintained at 120° C. for 2 h, and heated to 500° C. at 5 K/min. The temperature is maintained at 500° C. for 4 h and then cooled to ambient temperature. This experimental procedure is repeated once for the doubly silylated zeolite and twice for the triply silylated zeolite.

TABLE 5
Weighed-in quantities for silylation of AgZSM-5.

| | | | | Vₕₑₓₐₙₑ | V_{TEOS} |
|---|---|---|---|---|---|
| Example | Zeolite | Silylation | m_{zeolite}[g] | [ml] | [ml] |
| 23 | AgZSM5-S1 | 1. | 2.0226 | 50 | 0.3 |
| 24 | AgZSM5-S2 | 1. | 2.0167 | 50 | 0.3 |
| | | 2. | 1.7614 | 50 | 0.3 |
| 25 | AgZSM5-S3 | 1. | 3.0014 | 50 | 0.45 |
| | | 2. | 2.8018 | 50 | 0.45 |
| | | 3. | 2.6511 | 50 | 0.4 |

The silylated AgZSM-5 materials from Examples 23 to 25 are characterized below.
AgZSM-5-S1: singly silylated from Example 23
AgZSM-5-S2: doubly silylated from Example 24
AgZSM-5-S3: triply silylated from Example 25

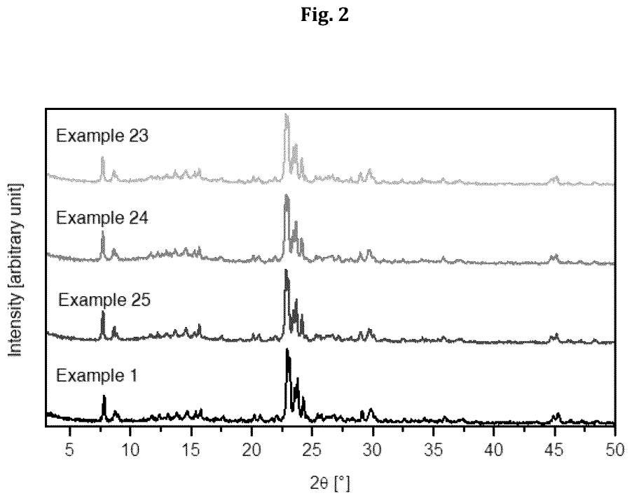

The XRD investigations (FIG. 2) show that the zeolite structure is not affected by the silylation processes.

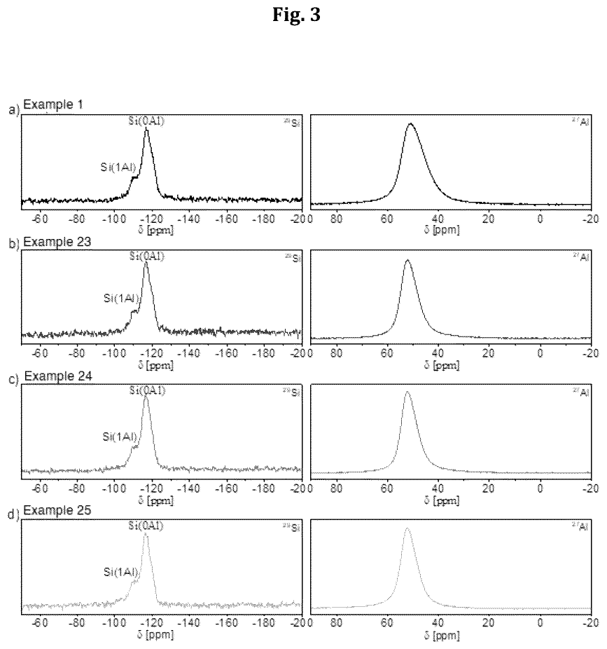

This finding is also confirmed by the 29Si and 27Al solid-state NMR spectra (FIG. 3). In the ²⁷Al NMR spectra, no octahedrally coordinated aluminum was able to be detected which would indicate damage to the crystal structure. No sign of SiO₂ was detected in the ²⁹Si solid-state NMR spectrum. The n(Si)/n(Al) ratio of zeolite NH₄ZSM-5 increased to 13.7 as a result of the ion exchange from Example 1 (Table 6).

As a result of the single treatment with TEOS in Example 23, the n(Si)/n(Al) ratio was increased to 16.6; an n(Si)/n(Al) ratio of 15.3 was determined for the double silylation in Example 24; and the n(Si)/n(Al) ratio is 16.3 for the triple silylation in Example 25. Thus, it was shown that the treatment with TEOS increased the silicon content in the specimen. The deviations of the n(Si)/n(Al) ratios among one another might be due to measurement inaccuracies or inaccuracies in the initial weighing.

TABLE 6
Determination of the n(Si)/n(Al) ratio of the
silylated zeolites and the starting zeolites.

| Example | Zeolite | n(Si)/n(Al) |
|---|---|---|
| — | NH₄ZSM-5 | 11.5* |
| 1 | AgZSM-5 | 13.7 |
| 23 | AgZSM-5-S1 | 16.6 |
| 24 | AgZSM-5-S2 | 15.3 |
| 25 | AgZSM-5-S3 | 16.3 |

*According to the manufacturer, the SiO₂/Al₂O₃ ratio is 23; converted into an n(Si)/n(Al) ratio, it is 11.5.

TABLE 7
Specific surface area and specific pore volume of
the silylated zeolites and the unsilylated AgZSM-5.

| Specimen | S_{BET} [m²/g] | V_{P} [ml/g] |
|---|---|---|
| AgZSM-5 | 303 | 0.19 |
| AgZSM-5-S1 | 292 | 0.18 |
| AgZSM-5-S2 | 282 | 0.18 |
| AgZSM-5-S3 | 274 | 0.17 |

The specific surface area and the specific pore volume were further reduced after each silylation step as a result of silylation (Table 7). However, the pore mouth constriction was not able to be determined directly.

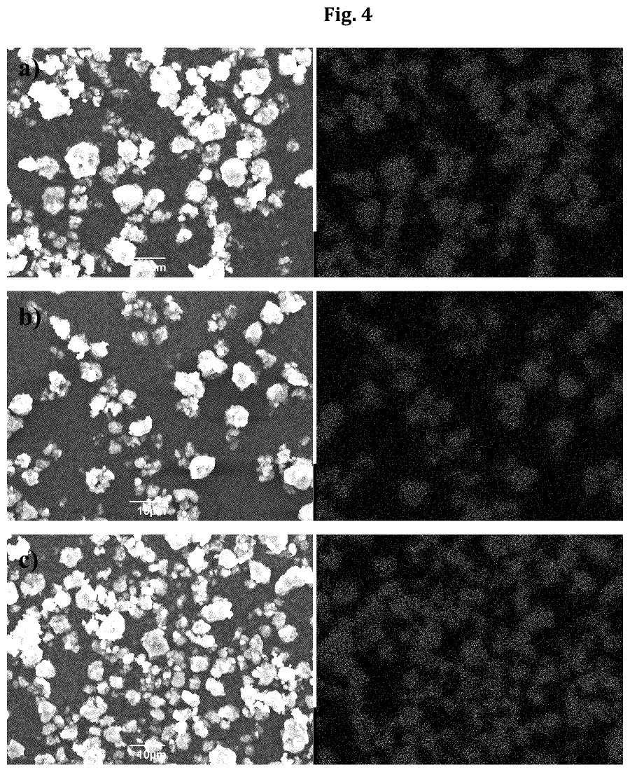

The EDX images in FIG. 4 show no differences between the non-silylated and the silylated materials.

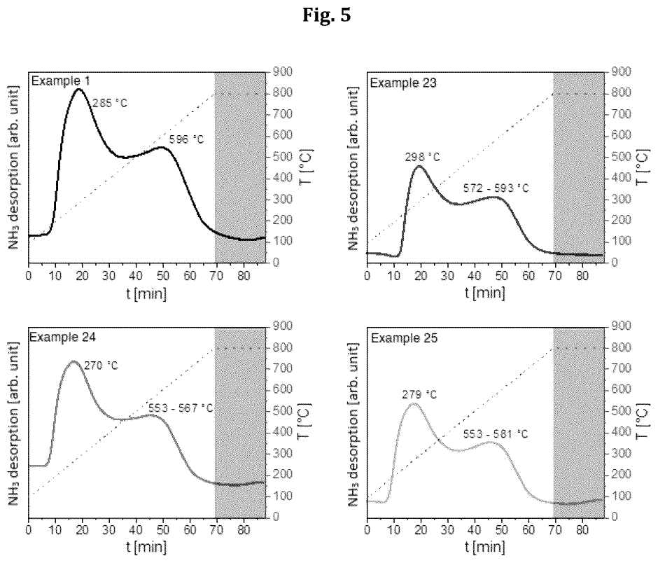

The NH₃ TPD measurements (FIG. 5) prove that the acid centers strength and their strength is influenced by the silylations. The NH₃ TPD measurements exhibit two signals. The low temperature signal between 270° C. and 288° C. is attributed to the desorption of weakly adsorbed ammonia. The high-temperature signal between 553° C. and 596° C. is attributed to the desorption of ammonia bound to acid centers. However, this setup is not able to distinguish between Lewis and Brønsted acid centers. Silylation shifts this signal to lower temperatures, with the exception of the triply silylated zeolite. Nevertheless, the triply silylated zeolite has a lower desorption temperature than the unsilylated zeolite AgZSM-5. The shift toward lower desorption temperatures indicates a weakening of the acid centers.

### Example 26

In Example 26, the leaching of Ag ions is investigated. The antibacterial zeolite substances from Examples 1, 23, 24, and 25 are used for the leaching tests in order to test the so-called “controlled release.” 30 mg of zeolite are placed into each 100 ml Erlenmeyer flask. 30 ml each of a 5% nitric acid is added to the respective zeolite material, and the Erlenmeyer flasks are sealed with a plastic stopper. Under exclusion of light, the respective suspensions were heated to 55° C. and shaken at 200 rpm. After 24 h, the solid was separated from the liquid by centrifugation. The silver content in the solution was analyzed by atomic absorption spectroscopy. The separated zeolite was again added to the Erlenmeyer flask with 30 ml of 5% by volume of nitric acid and shaken again for 24 h at 55° C. and 200 rpm. After another 24 hours, the procedure was repeated.

### Example 27

In Example 27, the antibacterial properties of zeolites loaded with Ag ions are tested. 40 mg of each of the zeolites to be investigated are kept in an autoclave at 121° C. for 15 min. 20 ml of LB medium (nutrient medium for cultivation of bacteria) are added. A dilution series is then created at 2000 μg/ml, 1000 μg/ml, 500 μg/ml, 250 μg/ml, 125 μg/ml, 62 μg/ml, 31 μg/ml, 15 μg/ml, 7.5 μg/ml, 0 μg/ml. The dilution series is applied to a 96-well plate, inoculated with 2 μl E. coli from a 1:10 diluted preculture, and incubated for 24 h at 37° C. and 220 rpm. Subsequently, the optical density at 600 nm (OD 600) was determined.

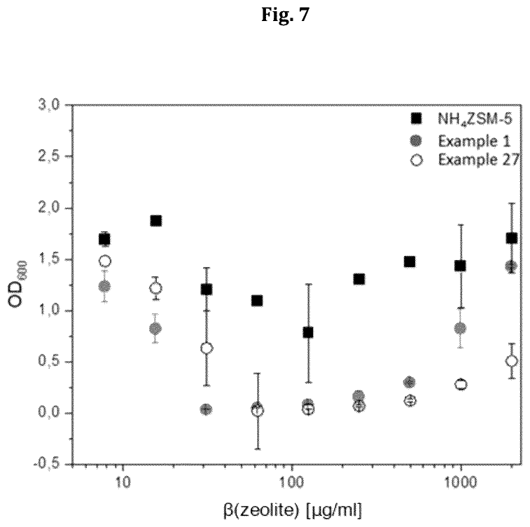

Zeolite NH₄ZSM-5 does not exhibit any antibacterial effect against E. coli in the OD600 measurements (FIG. 7). In contrast, AgZSM-5 from Example 1 exhibits antibacterial activity starting at a zeolite concentration of 31.25 μg/ml. When the singly silylated zeolite AgZSM-5-S1 from Example 23 is used, the antibacterial effect begins at a zeolite concentration of 62.5 μg/ml. The higher zeolite concentration of the silylated zeolite, which is required for the antibacterial effect, can be attributed to the silylation and the resulting slower leaching.

### Example 28

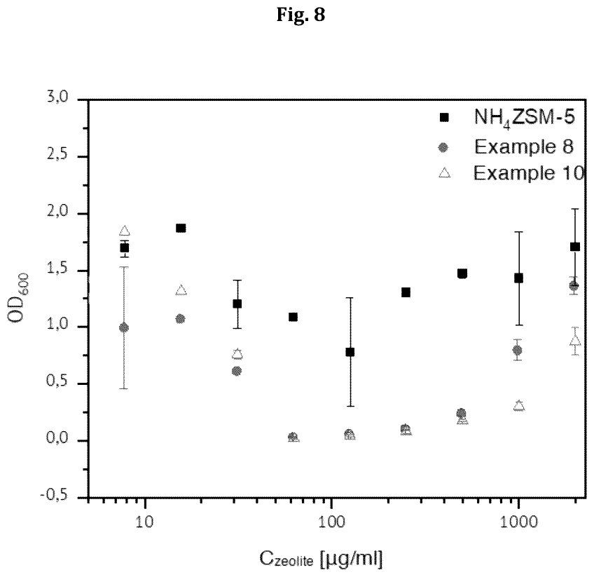

Zeolites with different Ag ion contents from Examples 8 and 11 are tested for their antibacterial properties. The test results can be seen in FIG. 8. It was found that zeolite NH₄ZSM-5 does not exhibit any antibacterial activity against E. coli in the OD600 measurements. In contrast, both Ag-exchanged zeolites from Examples 8 and 11 exhibit antibacterial activity starting at a concentration of 62.5 ug/ml. The slight increase in OD600 values at higher zeolite concentrations is due to the turbidity of the zeolite suspension and not to increased bacterial growth. Furthermore, it can be shown that the antimicrobial effect against E. coli is caused by silver, since zeolite NH₄ZSM-5, which serves as a support material, exhibits no antimicrobial effect against E. coli.

### Example 29

The ion exchange of BEA zeolite (beta zeolite) is carried out as described in Examples 9 and 10. Like in Example 10, a 0.05 M aqueous silver nitrate solution in 200 ml of aqueous distilled water is heated to the desired temperature in a 250 ml Erlenmeyer flask under stirring with a magnetic stirrer under exclusion of light. 2.0 g of CP 814E (NH₄-beta zeolite from Zeolyst International) are slowly added to the solution and stirred at 60° C. for 2 h. The opening of the Erlenmeyer flask was covered with a watch glass dish. During ion exchange, the pH value was set to a value between 7.0 and 7.1 using 25% NH₃ solution or diluted HNO₃. The solid was filtered off and dried at room temperature. This process is carried out a total of three times. A silver content of 7.3% by weight was achieved. This corresponds to an exchange rate of 61.3%.

### Example 30

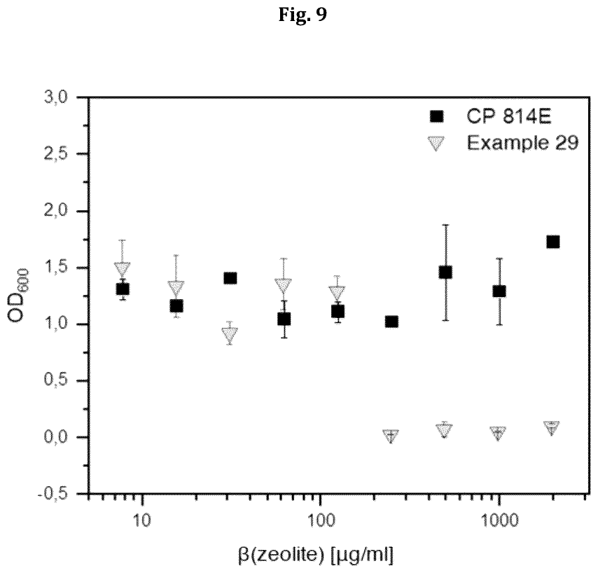

NH₄ beta zeolite does not exhibit any antibacterial effect against E. coli in the OD600 measurements (FIG. 9). Both silver ion-exchanged beta zeolites from Examples 29 exhibit antibacterial activity starting at a zeolite concentration of 250 μg/ml. The slight increase in OD600 values at higher zeolite concentrations is due to the turbidity of the zeolite suspension and not to increased bacterial growth.

### Example 31

For this example, which describes a compounding of the thermoplastic with the antibacterial zeolite without the addition of nitrogen, a quantity of 1000 kg of PPSU from Solvay (Radel R 5000) is used. kg of Ag ZSM-5 from Example 1 are used as antibacterial material. AgZSM-5 is added to the PPSU via a T20 gravimetric dosing system. During compounding, both components are mixed together on a Berstorff ZE 34 co-rotating twin-screw extruder, and the zeolitic material is incorporated into the polymer. The set temperatures on the extruder were between 360° C. and 375° C. The output of the extruder was approximately 25 kg/h. The melt is transferred into a strand through a die with four 3 mm diameter holes. The cooled strands are then cut into pieces approximately 3 mm long in a granulator.

An MFI (Melt Flow Index) measurement of the compound yields a value of 13.54 g/10 min at a temperature of 365° C. and a load of 5 kg. In order to check the quality of the compounding, an ashing process is carried out immediately. This yields a content of approximately 8% by weight of Ag-ZSM-5.

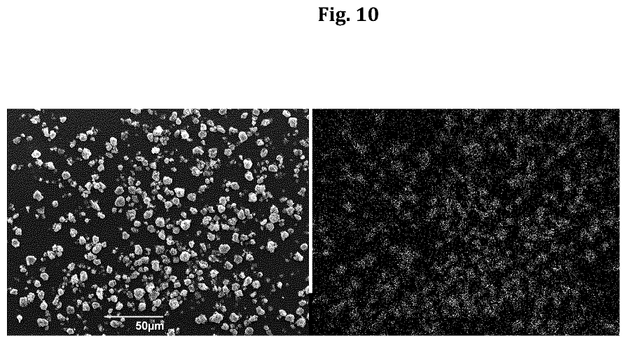

To investigate the uniform distribution of the zeolite in the polymer, an EDX (energy dispersive X-ray spectroscopy) image was carried out. This shows a uniform distribution of the antibacterial additive in the polymer (FIG. 10).

### Example 32

The compounding in Example 32 is comparable to Example 31, but it is carried out in the presence of nitrogen in a moisture-free atmosphere. For this purpose, the dosing of the zeolite into the extruder is covered with N₂. The advantages of compounding under N₂ are:

The zeolite is highly hygroscopic, which means that it very quickly absorbs moisture from the ambient air, which is then stored in the zeolite framework. During the extrusion process and the resulting high temperatures, this moisture escapes from the zeolite and causes the melt to foam. This poses a hindrance when manufacturing filaments and extruding tubes, rods, etc. This disadvantage is avoided by covering with nitrogen.

### Example 33

In Example 33, the leaching of Ag ions in the compounded material is investigated. In the following leaching tests, compounded PPSU filled with zeolite from Example 1 was investigated. Initially, the compounded PPSU was available as granulate from Example 32. This was then further processed into filament in a single-screw extruder from Hong San Fu Industrial Co, LTD, Taiwan. A 3D-printed test specimen was produced from this filament using the DLP (Digital Light Processing) process with the Apium P 115 Adaptive Heating System from Apium Additive Technology.

Seven pieces of each of the three materials to be tested were used. Each of these pieces had a mass of 42 mg. Each PPSU piece was placed in a crimp-top bottle and supplemented with 19 ml of 5% by volume of nitric acid. The crimp bottles were closed and placed in a metal block at 55° C. The solution was analyzed for the silver content leached from the PPSU filled with AgZSM-5 by atomic absorption spectroscopy. Sampling was done after one day, three days, 7 days, 14 days, 21 days, 28 days, and 42 days.

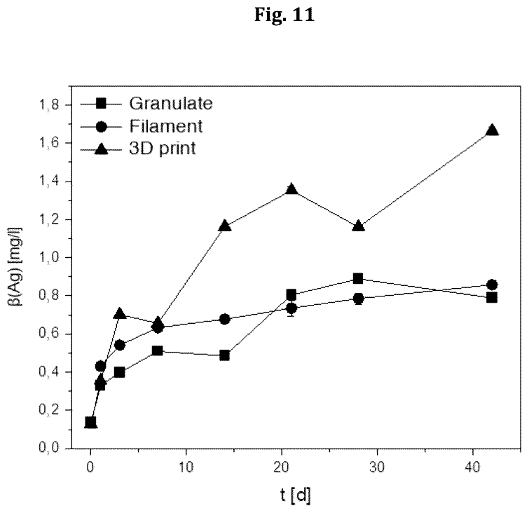

The results of these leaching tests are shown in FIG. 11. Continuous silver release was observed in all three comparison groups. It can be assumed that first the silver is released from the zeolites close to the surface and then the silver from the deeper zeolite framework layers. Despite the same masses, there are differences in silver release, which can be attributed to a different surface/volume ratio.

### Example 34

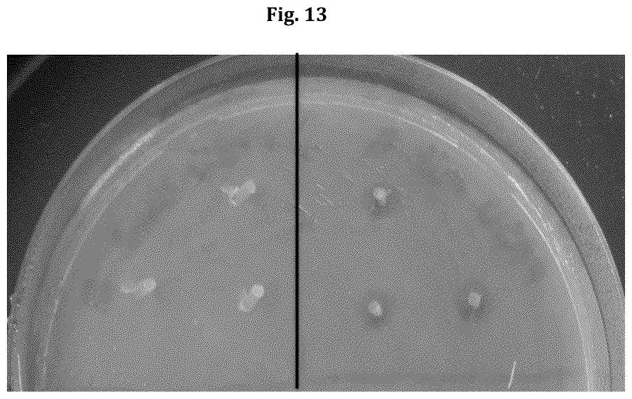

The antibacterial properties of the granulate of the compounded PSSU from Example 32, the filament, and the 3D printed test specimen from Example 33 were also tested. The results in FIG. 13 show the antibacterial efficacy.

### Example 35

Zone of inhibition test (FIG. 13) of the Ag zeolite-filled PPSU filament from Example 33 and the unfilled PPSU filament. The compounding material filled with zeolite AgZSM-5 from Example 1 and the PPSU filament without antibacterial zeolite additive are each cut into three equal-sized pieces, and the cut surface is smoothed using sandpaper. These filament pieces are autoclaved. E. coli is plated on agar plates, and these are exposed to the autoclaved filament pieces. The agar plates are incubated overnight at 37° C., and the zone of inhibition is then measured.

For the pure PPSU filament (left), no zone of inhibition value is detected (FIG. 13). In contrast, with the PPSU filament filled with AgZSM-5, zones of inhibition with diameters of 4-5 mm are measured.

It was demonstrated that the antibacterial effect against E. coli is due to zeolite AgZSM-5 and not to the PPSU filament.

### Example 36

Example 36 describes the preparation of antibacterial tubes. Such tubes can be used in the cosmetics industry and in the manufacture of writing instruments.

The cosmetic tube to be produced is a tube with the following dimensions: Outer diameter: 7.7 mm (±0.05 mm); inner diameter; 4.15 mm (±0.15 mm); length: 114.5 (+0.5 mm) For this purpose, a conical twin-screw extruder of type CE5 from Weber is used. A mixture of 50 kg PVC and 5 kg Ag-ZSM-5 is used in production. The temperatures during extrusion were approximately 150° C. in the infeed area and then rose to approximately 170° C. The die was set to a temperature of 160° C. The extruder ran at a speed of approximately 10 rpm. This resulted in a throughput of approximately 15 kg/h. The residence time in the extruder was approximately 1.5 minutes. A nozzle with a diameter of 7.0 mm was used as the die, and a mandrel with a diameter of 5.0 mm was used.

When manufacturing tubes for the cosmetics industry, a smooth outer surface is important. For this reason, the melt is calibrated in a vacuum basin after leaving the nozzle. The melt is applied to a water-cooled calibration due to a negative pressure. Water cooling with water temperature-controlled to about 20° C. ensured uniform cooling of the plasticized plastic. The applied negative pressure is approximately 0.3 bar.

In order to constantly draw off the continuous melt, an extractor system from Pickard is used. This runs at a speed of approximately 10 m/min.

The cutting device that was subsequently installed (built in-house by Gehr Kunststoffwerke) cut the tube to the required length of about 114 mm using a light barrier.

### Example 37

Example 37 describes the manufacture of a filament for 3D printing. The filaments are used for 3D printing of medical materials such as dental prostheses or bone replacements.

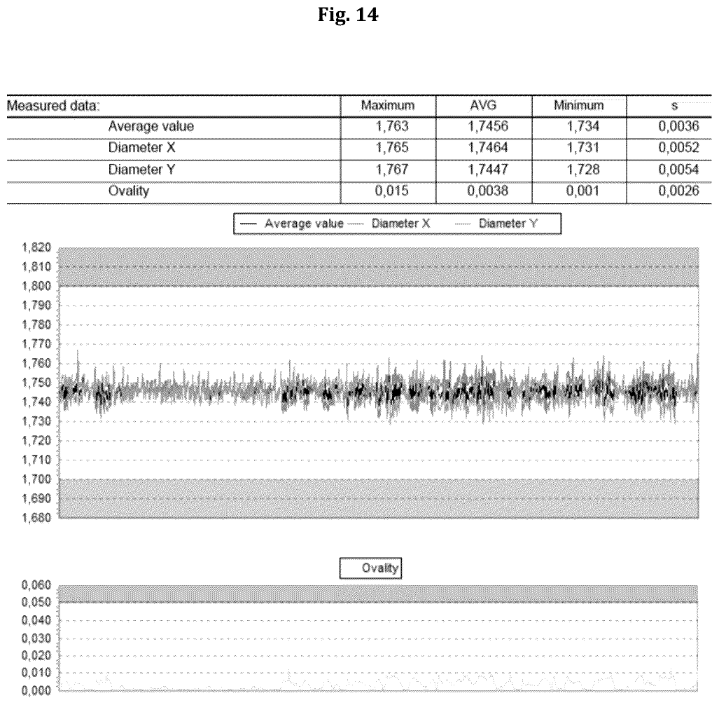

To manufacture filaments with a diameter of 1.75 mm, a single-screw extruder from Hong San Fu Industrial Co. LTD, Taiwan with a screw diameter of 45 mm is used. The granulate provided from compounding Example 35 was pre-dried at 170° C. in a dry air cabinet for 12 hours before processing. The dried material is fed into the extruder hopper in pre-dried air via a pneumatic feed. There, the material falls into the cylinder with the screw. This conveys the drawn-in material and plasticizes it. The temperature set at the cylinder is between 340° C. and 350° C. The extruder is followed by a distributor bar, which divides the melt into two flows. Two melt pumps are flanged behind the distributor bar, which ensure a uniform volume flow. The melt pumps transport the melt through the dies at a speed of about 24 rpm. These have a diameter of 1.55 mm. This results in an output of approximately 10 kg/h. In order to cool the melt after it leaves the die, various air nozzles are attached thereto. These cool the filament with the aid of oil-free air. Each extractor pulls off one strand. The filament is fed via a buffer into a winder, where it is wound onto spools. The length of the filament is set at 635 m, which corresponds to a spool weight of approximately 1 kg. Before entering the winder, each filament passes through a laser measuring system from Zumbach, S, which measures the outer diameter of the filament on two axes each. An evaluation of the recorded diameters of a filament spool is shown in FIG. 14.

### Example 38

In Example 38, approximately 1% by weight of calcium fluoride is additionally added to the compound. This is expected to have a positive influence on the manufacture of dental crowns, for example.

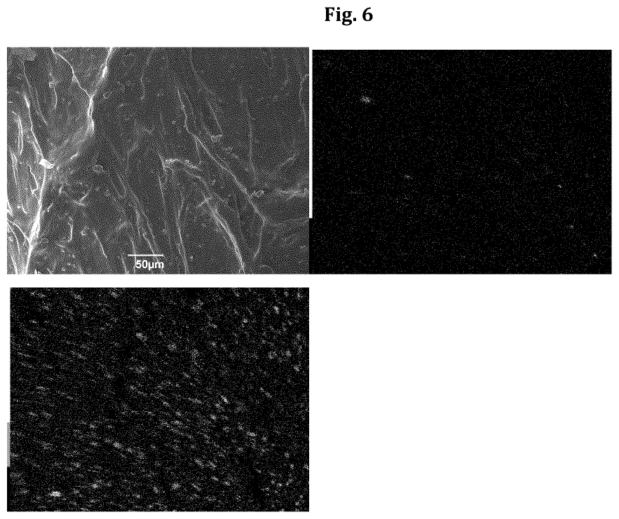

Compared to Example 33, there is no major difference in the processing in Example 38. The SEM and EDX images below are shown in order to illustrate the zeolite and calcium fluoride distribution (FIG. 6).

However, processing the compound with only drummed calcium fluoride is not possible. The material foams too much after leaving the nozzle. Only through the compounding process can the material be processed satisfactorily on the filament system. The set parameters are comparable to the process shown in Example 33.

1. An antibacterial thermoplastic substrate comprising at least one thermoplastic and at least one framework silicate, wherein the framework silicate contains at least one antibiotic metal and/or antibiotic metal ion, characterized in that the substrate has a silicate layer on at least a portion of the outer surface.

2. The antibacterial thermoplastic substrate according to claim 1, characterized in that the thermoplastic is selected from the group consisting of polyetheretherketone (PEEK), polyoxymethylene (POM), polyvinyl chloride (PVC), polyphenylsulfone (PPSU), and mixtures thereof.

3. The antibacterial thermoplastic substrate according to claim 1, characterized in that the framework silicate is zeolite, in particular a zeolite of the class of the aluminosilicates, in particular an ion-exchanged zeolite, the ion-exchanged zeolite in particular comprising ion-exchangeable ammonium ions.

4. The antibacterial thermoplastic substrate according to claim 3, characterized in that the aluminosilicates of the structural type are selected from the group consisting of pentasil zeolites such as ZSM-5, BEA, mordenite, L, Y, X, theta zeolites, and mixtures thereof.

5. The antibacterial thermoplastic substrate according to claim 1, characterized in that the framework silicate is temperature-stable.

6. The antibacterial thermoplastic substrate according to claim 1, characterized in that the antibiotic metal or metal ion is a noble metal and/or a transition metal.

7. The antibacterial thermoplastic substrate according to claim 1, characterized in that the antibiotic metal or metal ion is selected from the group consisting of gold, silver, copper, cobalt, zinc, mercury, tin, lead, bismuth, cadmium, chromium, thallium, and mixtures thereof.

8. The antibacterial thermoplastic substrate according to claim 1, characterized in that the framework silicate comprising an antibiotic metal and/or an antibiotic metal ion is a silylated zeolite.

9. A method for manufacturing an antibacterial thermoplastic substrate, comprising the steps:
a) applying/introducing the antibiotic metal and/or metal ion onto/into the framework silicate through ion exchange and/or impregnation,
b) silylating the metal-doped framework silicates, and
c) mixing the silylated metal-doped framework silicates with the thermoplastic.

10. The manufacturing method according to claim 9, characterized in that the antibacterial thermoplastic substrate is an antibacterial thermoplastic substrate having at least one thermoplastic and at least one framework silicate, wherein the framework silicate contains at least one antibiotic metal and/or antibiotic metal ion, characterized in that the substrate has a silicate layer on at least a portion of the outer surface.

11. The manufacturing method according to claim 9, characterized in that the silylation of the framework silicate is carried out by treatment with silicon compounds such as tetrachlorosilane, trichlorosilane, dichlorosilane, monochlorosilane, tetraethylsilane, triphenylsilane, triphenylchlorosilane, phenyltrichlorosilane, trimethylchlorosilane, tetramethylsilane, triethylchlorosilane, and/or diethylchlorosilane.

12. The manufacturing method according to claim 9, characterized in that the metal-doped, silylated framework silicate is subjected to tempering, wherein the temperature range of the tempering is in particular between 450° C. and 600° C., preferably 500° C. to 550° C., and wherein the duration of the tempering is between 3 to 12 hours, preferably 4 to 8 hours. and especially preferably 5 to 6 hours.

13. The manufacturing method according to claim 9, characterized in that a mixture of thermoplastic and metal-doped, silylated framework silicate is compounded and then processed into granulate.

14. The manufacturing method according to a claim 9, characterized in that the granulate is processed into tubes, rods, plates, hollow bars, profiles, foils, and/or wires.

15. The manufacturing method according to claim 9, characterized in that the granulate is further processed into filaments for 3D printing.

16. A use of the antibacterial thermoplastic substrate according to claim 1 for the manufacture of medical, cosmetic, and/or construction products, for semi-finished products for automotive, mechanical, apparatus, and tool engineering, in particular for chemical plants, in the pharmaceutical, food, and packaging industries, in the electrical and electronics sector, in sanitary and furniture production, in water treatment and the drinking water industry, in sealing materials such as silicone seals in bathrooms, in the manufacture of cosmetic and writing instruments and/or in the oil and gas industry.
